(19) United States
(12) Patent Application Publication
(10) Pub. No.: US 2023/0411900 A1
(43) Pub. Date: Dec. 21, 2023

(54) GASKET-EQUIPPED FLEXIBLE PRINTED WIRING BOARD AND METHOD FOR MANUFACTURING GASKET-EQUIPPED FLEXIBLE PRINTED WIRING BOARD

(71) Applicant: NIPPON MEKTRON, LTD., Tokyo (JP)

(72) Inventors: Takashi SASAKI, Tokyo (JP); Eiichi INOUE, Tokyo (JP)

(73) Assignee: NIPPON MEKTRON, LTD., Tokyo (JP)

(21) Appl. No.: 18/169,103

(22) Filed: Feb. 14, 2023

(30) Foreign Application Priority Data
Jun. 20, 2022 (JP) 2022-099062

(51) Int. Cl. H01R 13/52; H01R 12/77; H01R 43/24

(52) U.S. Cl. CPC H01R 13/521; H01R 12/771; H01R 43/24

(57) ABSTRACT

Provided is a gasket-equipped flexible printed wiring board including: a flexible printed wiring board with a through-hole; and a gasket, in which the gasket is provided integrally with the flexible printed wiring board so as to embed a partial region of the flexible printed wiring board in such a manner that the gasket is molded on the flexible printed wiring board, which is an insert component, by insert molding, the gasket has a gate mark on a first end side of the flexible printed wiring board in a width direction thereof, and the through-hole is, within the partial region of the flexible printed wiring board, formed at a position closer to a second end side, which faces the first end side in the width direction, than to the first end side.

### CROSS-REFERENCE TO RELATED APPLICATION

This application claims priority from Japanese Patent Application No. 2022-099062 filed with the Japan Patent Office on Jun. 20, 2022, the entire content of which is hereby incorporated by reference.

### BACKGROUND

### 1. Technical Field

The present disclosure relates to a gasket-equipped flexible printed wiring board and a method for manufacturing the gasket-equipped flexible printed wiring board.

### 2. Related Art

Typically, a gasket-equipped flexible printed wiring board including a flexible printed wiring board (hereinafter sometimes referred to as an “FPC”) and a gasket provided integrally with the FPC has been known (see Japanese Patent No. 5354281 and JP-A-2016-100492, for example). Such a gasket-equipped FPC can be obtained in such a manner that the gasket is molded on the FPC, which an insert component, by insert molding. A method for manufacturing the gasket-equipped FPC according to the prior art will be described with reference to FIGS. 8A and 8B. FIGS. 8A and 8B are views for describing insert molding according to the prior art. A die 50 for insert molding includes an upper die 510 and a lower die 520. Engraved portions 511, 521 each formed at the upper die 510 and the lower die 520 form a cavity C. The die 50 is further provided with an arrangement portion in which an FPC 600 is to be arranged. The FPC 600 arranged in the arrangement portion is arranged so as to penetrate the cavity C. The upper die 510 is provided with agate 512 and a vent 513 such that the gate 512 and the vent 513 face the lower die 520 on both sides of the arrangement portion.

The die 50 configured as described above is clamped after the FPC 600 has been arranged in the arrangement portion of the die 50, and a gasket is molded in such a manner that the material (hereinafter sometimes referred to as a material or a molding material) of the gasket is inserted through the gate 512. In this manner, the gasket can be provided integrally with the FPC 600.

However, in the typical manufacturing method, the material easily flows on a lower die 520 side than an upper die 510 side with respect to the FPC 600, and for this reason, the flowability of the material is non-uniform between the lower die 520 side and the upper die 510 side. As a result, there is a problem that insufficient filling with the material is easily caused. That is, as indicated by arrows in FIG. 8A, the material easily flows to the lower die 520 side than to the upper die 510 side. For this reason, as indicated by arrows in FIG. 8B, the material flowing on the lower die 520 side passes by an inlet of the vent 513 and flows to the upper die 510 side so as to flow around the FPC 600, and therefore, the material flows are joined together in the vicinity of an upper surface of the FPC 600. For this reason, insufficient filling with the material is easily caused at such a joint portion (the vicinity of a portion indicated by X in FIG. 8B).

Note that the FPC 600 has a high flexibility, and therefore, is deformed if the pressure of the injected material is increased. For this reason, there is a limitation on measures taken to reduce insufficient filling with the material by an increase in the pressure of the injected material.

### SUMMARY

A gasket-equipped flexible printed wiring board according to an embodiment of the present disclosure is configured to include, a flexible printed wiring board with a through-hole; and a gasket. The gasket-equipped flexible printed wiring board is configured such that the gasket is provided integrally with the flexible printed wiring board so as to embed a partial region of the flexible printed wiring board in such a manner that the gasket is molded on the flexible printed wiring board, which is an insert component, by insert molding, the gasket has a gate mark on a first end side of the flexible printed wiring board in a width direction thereof, and the through-hole is, within the partial region of the flexible printed wiring board, formed at a position closer to a second end side, which faces the first end side in the width direction, than to the first end side.

### BRIEF DESCRIPTION OF THE DRAWINGS

FIG. 1 is a partial plan view of a gasket-equipped flexible printed wiring board according to a first embodiment of the present disclosure;

FIGS. 2A and 2B are schematic views showing a configuration in a state in which the gasket-equipped flexible printed wiring board according to the first embodiment of the present disclosure is attached to a device;

FIG. 3 is a partial plan view of a flexible printed wiring board according to the first embodiment of the present disclosure:

FIGS. 4A and 4B are views for describing a method for manufacturing the gasket-equipped flexible printed wiring board according to the first embodiment of the present disclosure;

FIGS. 5A and 5B are views for describing the method for manufacturing the gasket-equipped flexible printed wiring board according to the first embodiment of the present disclosure;

FIG. 6 is a partial plan view of a flexible printed wiring board according to a second embodiment of the present disclosure:

FIGS. 7A and 7B are views for describing a method for manufacturing a gasket-equipped flexible printed wiring board according to the second embodiment of the present disclosure; and

FIGS. 8A and 8B are views for describing insert molding according to the prior art.

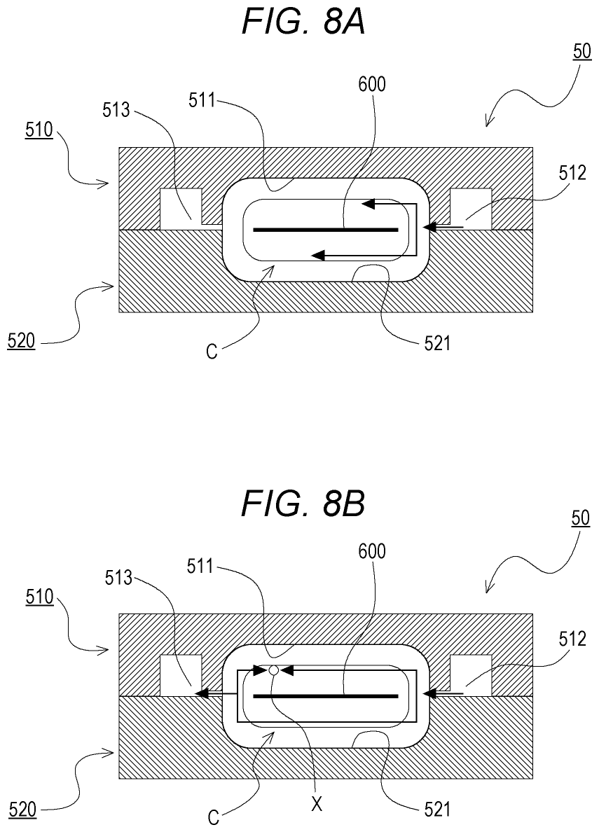

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

One object of the present disclosure is to provide a gasket-equipped flexible printed wiring board and a method for manufacturing the gasket-equipped flexible printed wiring board, which are capable of reducing a molding defect.

The present disclosure employs the following configurations.

A gasket-equipped flexible printed wiring board according to an aspect of the present disclosure includes: a flexible printed wiring board with a through-hole; and a gasket. In the gasket-equipped flexible printed wiring board, the gasket is provided integrally with the flexible printed wiring board so as to embed a partial region of the flexible printed wiring board in such a manner that the gasket is molded on the flexible printed wiring board, which is an insert component, by insert molding, the gasket has a gate mark on a first end side of the flexible printed wiring board in a width direction thereof, and the through-hole is, within the partial region of the flexible printed wiring board, formed at a position closer to a second end side, which faces the first end side in the width direction, than to the first end side.

According to the present disclosure, in a case where there is a difference in the flow of a material between the upper and lower sides of the flexible printed wiring board in insert molding, the material flowing faster can flow to a slower flow side through the through-hole. Thus, the difference in the flow of the material between the upper and lower sides of the flexible printed wiring board in a region closer to a gate side with respect to the through-hole can be eliminated in a region closer to a vent side (the side opposite to the gate side) with respect to the through-hole.

It is preferred that the gasket has an annular seal protrusion, and the seal protrusion is provided so as to surround the flexible printed wiring board, and in a case where the flexible printed wiring board is vertically seen through a surface thereof, the through-hole is formed so as to protrude from both sides of the seal protrusion in a lateral direction thereof.

A portion with the annular seal protrusion has a greater volume than that of a portion without the seal protrusion, and therefore, insufficient filling with the material is likely to be caused in the vicinity of a tip end of the seal protrusion. On the other hand, the above-described configuration is employed so that the difference in the flow of the material in the vicinity of the seal protrusion can be reduced, and therefore, insufficient filling with the material in the vicinity of the tip end of the seal protrusion can be reduced.

It is preferred that the flexible printed wiring board has a plurality of lines, and the through-hole is a long hole elongated in a direction in which the lines extend and is formed so as not to overlap with the lines.

With this configuration, the area of the through-hole can be expanded without an adverse effect on the lines.

A method for manufacturing a gasket-equipped flexible printed wiring board according to the present disclosure includes: forming a through-hole at a position closer to a second end side, which faces a first end side of a flexible printed wiring board in a width direction thereof, than to the first end side; preparing a die having an arrangement portion in which the flexible printed wiring board is to be arranged and a gate and a vent each formed on both sides of the arrangement portion; arranging the flexible printed wiring board in the arrangement portion of the die such that the through-hole is at a position closer to the vent than to the gate; and molding a gasket integrally with the flexible printed wiring board by injecting a material into a cavity of the die through the gate after the die has been clamped.

Note that the above-described configurations may be employed in combination to the extent possible.

As described above, according to the present disclosure, the molding defect can be reduced.

Hereinafter, an exemplary mode for carrying out the present disclosure will be described in detail based on an embodiment with reference to the drawings. Note that unless otherwise specified, the dimensions, materials, shapes, relative arrangement, and the like of components described in this embodiment do not limit the scope of the present disclosure.

### First Embodiment

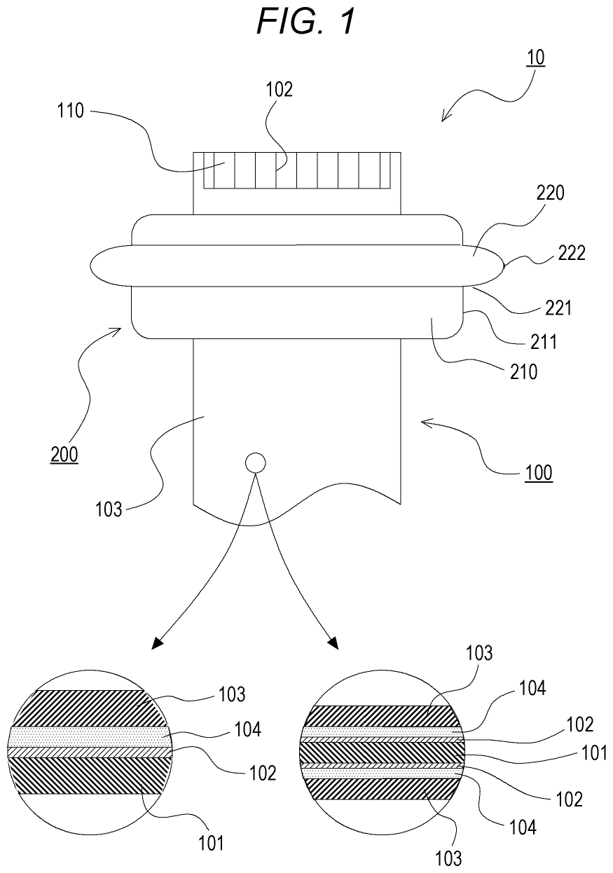

A gasket-equipped flexible printed wiring board and a method for manufacturing the gasket-equipped flexible printed wiring board according to a first embodiment of the present disclosure will be described with reference to FIG. 1 to FIGS. 5A and 5B. Note that in description below, the material of a gasket will be sometimes referred to as a material or a molding material.

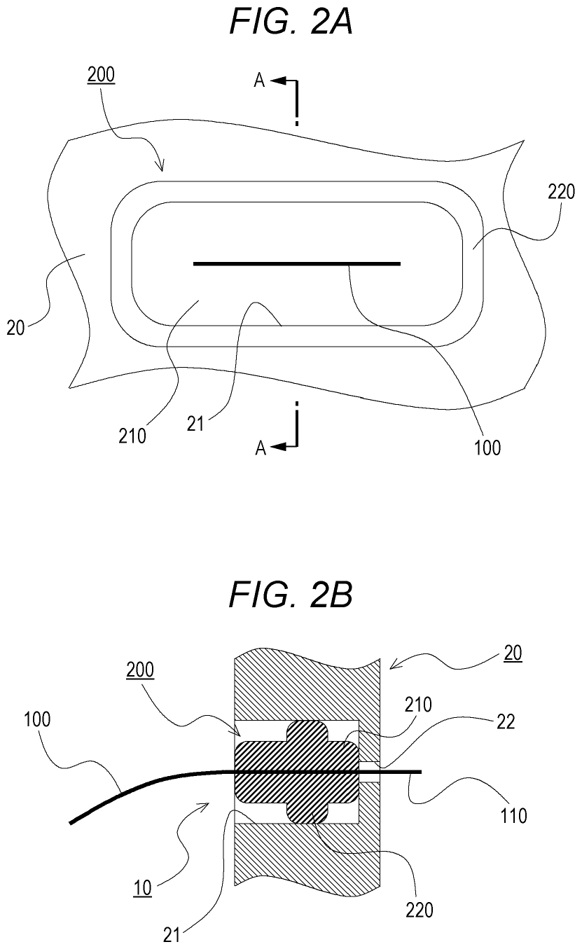

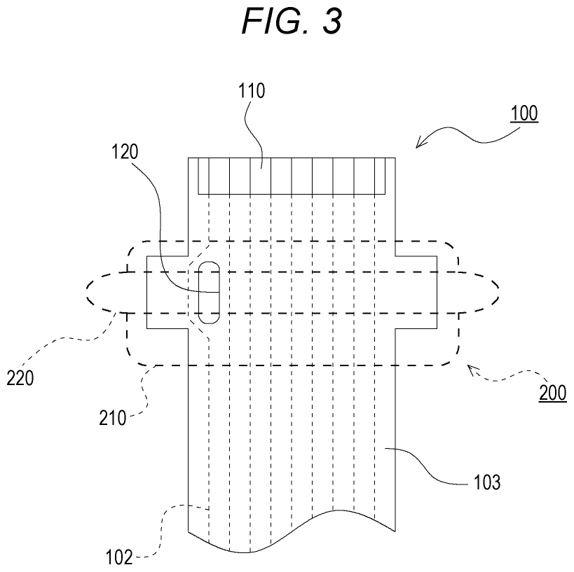

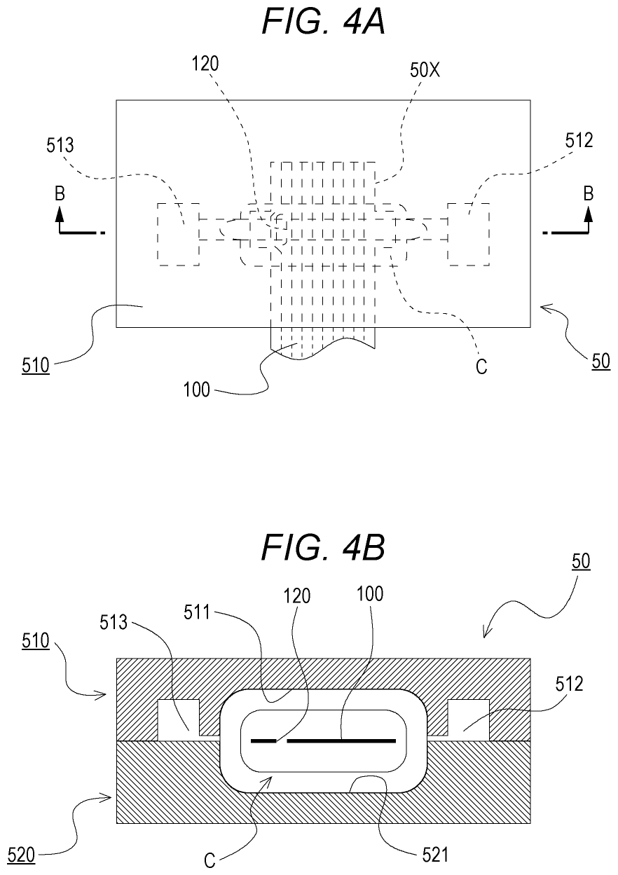

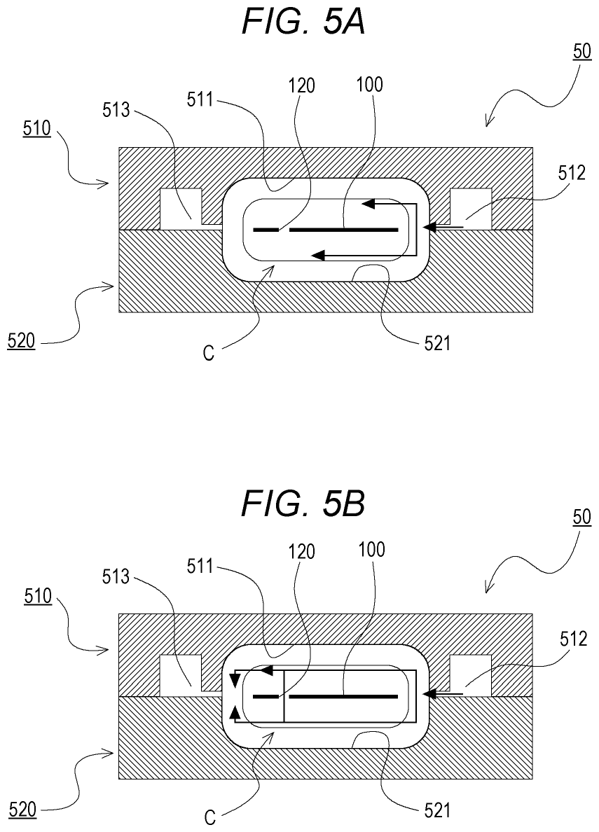

An upper view of FIG. 1 is a partial plan view of the gasket-equipped flexible printed wiring board according to the first embodiment of the present disclosure. Note that a lower left view and a lower right view of FIG. 1 show schematic sectional views of a portion surrounded by a circle in the plan view. FIGS. 2A and 2B are schematic views showing a configuration in a state in which the gasket-equipped flexible printed wiring board according to the first embodiment of the present disclosure is attached to a device. FIG. 2A is a front view showing a state in which the gasket-equipped flexible printed wiring board is attached to a case of the device, and FIG. 2B is a sectional view along an AA line in FIG. 2A. Note that FIGS. 2A and 2B only show the vicinity of a portion to which the gasket-equipped flexible printed wiring board is attached. FIG. 3 is a partial plan view of a flexible printed wiring board according to the first embodiment of the present disclosure. Note that in FIG. 3, a position at which the gasket is provided is indicated by a dashed line. FIGS. 4A, 4B, 5A, and 5B are views for describing the method for manufacturing the gasket-equipped flexible printed wiring board according to the first embodiment of the present disclosure. Note that FIG. 4A is a plan view showing a state in which the flexible printed wiring board is arranged in a die and the die is clamped and FIG. 4B is a sectional view along a BB line in FIG. 4A. In FIG. 4A, a main configuration is indicated by a dashed line. FIGS. 5A and 5B show the flow of the molding material in insert molding, FIG. 5A showing a state at an initial stage of molding and FIG. 5B showing a state at a late stage of molding.

### <Gasket-Equipped Flexible Printed Wiring Board>

A configuration of a gasket-equipped flexible printed wiring board 10 according to the present embodiment will be described with reference to FIG. 1. The gasket-equipped flexible printed wiring board 10 includes a flexible printed wiring board (hereinafter sometimes referred to as an “FPC 100”) and a gasket 200 provided integrally with the FPC 100. The gasket 200 is provided integrally with the FPC 100 in such a manner that the gasket 200 is molded on the FPC 100, which is an insert component, by insert molding.

Hereinafter, structure examples of the FPC 100 will be described. The lower left view and the lower right view of FIG. 1 are sectional views of the structure examples of the FPC 100. The FPC 100 shown in the lower left sectional view of FIG. 1 includes a base film 101, a plurality of lines 102 provided on the base film 101 and formed by etching of copper foil, and a cover film 103 covering the plurality of lines 102. The cover film 103 is, after the lines 102 have been formed, fixed to the base film 101 and the lines 102 with an adhesive 104. The FPC 100 shown in the lower right sectional view of FIG. 1 is, on each surface of a base film 101, provided with lines 102, an adhesive 104, and a cover film 103. Note that the lines 102 are formed by etching of copper foil. The present disclosure is not limited to the FPCs with these structures, but is applicable to FPCs with various structures.

A tip end 110 of the FPC 100 is provided with a portion with no cover film 103, and each of tip ends of the plurality of lines 102 is exposed.

The gasket 200 is provided so as to embed a partial region of the FPC 100. The gasket 200 includes a gasket body 210 and an annular seal protrusion 220. The seal protrusion 220 is provided so as to surround the FPC 100. The gasket 200 according to the present embodiment is provided such that the partial region of the FPC 100 is embedded in the gasket 200 with both ends of the FPC 100 in a width direction (a lateral direction) thereof surrounded by the gasket 200. The gasket 200 is in a shape substantially symmetrical with respect to the FPC 100.

### Use Example of Gasket-Equipped Flexible Printed Wiring Board

A use example of the gasket-equipped flexible printed wiring board 10 according to the present embodiment will be described with reference to FIGS. 2A and 2B. The gasket-equipped flexible printed wiring board 10 according to the present embodiment is applicable to various devices. For example, the gasket-equipped flexible printed wiring board 10 is provided in various devices such that the FPC 1X) is drawn out of the device. In the case of the example shown in FIGS. 2A and 2B, a case 20 of the device is provided with a gasket attachment portion 21 and a communication hole 22. The gasket attachment portion 21 is provided in such a manner that part of the case 20 is recessed. The communication hole 22 is provided such that the gasket attachment portion 21 and the inside of the case 20 communicate with each other. The tip end 110 of the FPC 100 is inserted into the case 20 configured as described above so as to passe through the communication hole 22, and the gasket 200 is attached to the gasket attachment portion 21. In this manner, the gasket-equipped flexible printed wiring board 10 is attached to the case 20 of the device. Note that various lines or circuit boards provided in the device are electrically connected to the plurality of lines 102 at the tip end 110 of the FPC 100. With the above-described configuration, electricity can be sent from the inside to the outside of the device or from the outside to the inside of the device. Moreover, the communication hole 22 can be closed with the gasket 200, and therefore, entrance of a foreign substance into the device from the outside of the device can be reduced.

### <FPC>

The FPC 100 according to the present embodiment will be described in more detail with reference to FIG. 3. Hereinafter, in the width direction which is the lateral direction of the FPC 100, the right end as viewed in the figure will be referred to as a “first end,” and the left end facing the first end in the width direction as viewed in the figure will be referred to as a “second end.”

A through-hole 120 is formed in the FPC 100. The through-hole 120 is, in the FPC 100, formed at a position closer to the second end side in the width direction. That is, the through-hole 120 is formed at a position closer to the second end side, which faces the first end side in the width direction of the FPC 100, than to the first end side in the width direction. The plurality of lines 102 is provided in the FPC 100. The above-described through-hole 120 is a long hole elongated in a direction in which the lines 102 extend, and is formed so as not to overlap with these lines 102. The through-hole 120 is formed within a region of the FPC 100 embedded in the gasket 200. Specifically, in a case where the FPC 100 is vertically seen through a surface thereof, the through-hole 120 is formed so as to partially overlap with the seal protrusion 220 of the gasket 200. More specifically, in a case where the FPC 100 is vertically seen through the surface thereof, the through-hole 120 is formed so as to protrude from both sides of the seal protrusion 220 in a lateral direction thereof. That is, it is configured such that the width of the through-hole 120 in a longitudinal direction thereof is greater than the width of the seal protrusion 220 in the lateral direction thereof.

### <Manufacturing Method>

A method for manufacturing the gasket-equipped flexible printed wiring board 10 according to the present embodiment will be described with reference to FIGS. 4A, 4B, 5A, and 5B.

### «Step of Manufacturing FPC 100»

First, copper foil provided on the base film 101 is etched, and desired lines 102 are formed accordingly. Thereafter, the cover film 103 is bonded with the adhesive 104. Then, in the case of the present embodiment, after the cover film 103 has been bonded, the through-hole 120 is formed in the FPC 100. The through-hole 120 is formed at the position closer to the second end side, which faces the first end side in the width direction of the FPC 100, than to the first end side in the width direction.

### «Insert Molding Step»

A configuration of a die 50 used for insert molding will be described. The die 50 includes an upper die 510 and a lower die 520. Engraved portions 511, 521 each formed at the upper die 510 and the lower die 520 form a cavity C. The die 50 is further provided with an arrangement portion 50X in which the FPC 100 as the insert component is to be arranged. The arrangement portion 50X may be provided, for example, in such a manner that a groove matching the outer shape of the FPC 100 is formed at the lower die 520. The FPC 100 arranged in the arrangement portion 50X is arranged so as to penetrate the cavity C as viewed in plane (see FIG. 4A).

Agate 512 is formed on the first end side (the right end side as viewed in the figure) in the upper die 510, and a vent 513 is formed on the second end side (the left end side as viewed in the figure) in the upper die 510. The gate 512 is formed so as to face the lower die 520 on the first end side of the arrangement portion 50X of the lower die 520. The vent 513 is formed so as to face the lower die 520 on the second end side of the arrangement portion 50X of the lower die 520. The gate 512 according to the present embodiment is a side gate, and is a gate type of inserting the material along a parting line of the die 50. The vent 513 is formed on the opposite side of the cavity C from the gate 512.

The FPC 100 is arranged in the arrangement portion 50X of the die 50 configured as described above. In this case, the FPC 100 is arranged in the arrangement portion 50X such that the through-hole 120 of the FPC 100 is at a position closer to the vent 513 than to the gate 512. Thereafter, the die 50 is clamped, and the material is inserted through the gate 512 to mold the gasket 200. In this manner, the gasket 200 is provided integrally with the FPC 100.

Thereafter, the die is opened, and the FPC 100 integrated with the gasket 200 is taken out of the die. Aftertreatment such as removal of burrs is performed, and then, the gasket-equipped flexible printed wiring board 10 is obtained.

At the gasket-equipped flexible printed wiring board 10 obtained by the above-described manufacturing method, a gate mark 222 is, in insert molding, formed at the first end of the gasket 200 in the width direction which is the lateral direction of the FPC 100 (see FIG. 1). In FIG. 1, the gate mark 222 is formed on the first end side (the right end side as viewed in the figure) of the seal protrusion 220 of the gasket 200. Note that the first end side of the seal protrusion 220 corresponds to the side on which the gate 512 is positioned in insert molding.

The gate mark 222 is formed on a parting line mark 221. Note that the parting line marks 211, 221 are each formed on the gasket body 210 and the seal protrusion 220.

As described above, the through-hole 120 of the FPC 100 is provided at the position closer to the second end side than to the first end side in the width direction of the FPC 100 within the region embedded in the gasket 200. In insert molding, the FPC 100 is arranged in the arrangement portion 50X such that the through-hole 120 is arranged at the position closer to the vent 513 than to the gate 512. The through-hole 120 is formed for controlling the flow of the material of the gasket 200 in insert molding.

### <Advantages of Gasket-Equipped Flexible Printed Wiring Board and Method for Manufacturing Gasket-Equipped Flexible Printed Wiring Board According to Present Embodiment>

In the present embodiment, the through-hole 120 configured as described above is formed in the FPC 100 so that the flow of the molding material (the material of the gasket 200) can be controlled (adjusted) as described below. In FIG. 5A, the flow of the material at the initial stage of molding is indicated by arrows. In FIG. 5B, the flow of the material at the late stage of molding is indicated by arrows. As shown in FIG. 5A, the molding material inserted into the cavity C through the gate 512 more easily flows to a lower die 520 side than to an upper die 510 side due to the force of gravity. Thus, the speed of the flow of the molding material is faster on the lower die 520 side than the upper die 510 side. In the present embodiment, the through-hole 120 is positioned closer to the vent 513 than to the gate 512 in insert molding. Thus, part of the material having reached the position of the through-hole 120 through the lower die 520 side flows to the upper die 510 side through the through-hole 120. Accordingly, the flow of the material flowing on the lower die 520 side slows down, and the material flowing on the upper die 510 side catches up with the flow of the material flowing on the lower die 520 side. Eventually, the flow of the material flowing on the lower die 520 side (the lower side of the FPC 100) and the flow of the material flowing on the upper die 510 side (the upper side of the FPC 100) are joined together in the vicinity of an inlet of the vent 513.

As described above, according to the present disclosure, a difference in the flow of the material between the upper and lower sides of the FPC 100 in the region closer to a gate 512 side with respect to the through-hole 120 can be eliminated in the region closer to a vent 513 side (the side opposite to the gate 512 side) with respect to the through-hole 120. That is, non-uniformity in the flow of the material between the upper die 510 side and the lower die 520 side can be eliminated by the through-hole 120. Thus, insufficient filling with the material can be reduced, and a molding defect can be reduced.

Note that even in a case where the material of the gasket 200 is a material having a low flowability, such as high consistency rubber or a resin material, the configuration of the present embodiment is employed so that the molding defect can be reduced. Thus, various rubber materials, various resin materials, and various thermoplastic elastomer materials can be employed as the material of the gasket 200, leading to a wider range of choices for the material.

Both sides of the gasket 200 with respect to the FPC 100 are connected to each other through the through-hole 120, and therefore, dropping of the gasket 200 from the FPC 100 can also be reduced. Note that in the present embodiment, the same die as a typical die can be employed without change, and therefore, an increase in a manufacturing cost can also be suppressed.

In the present embodiment, the annular seal protrusion 220 is, at the gasket 200, provided so as to surround the FPC 100. In a case where the FPC 100 is vertically seen through the surface thereof, the through-hole 120 is formed so as to protrude from both sides of the seal protrusion 220 in the lateral direction thereof. The portion with the annular seal protrusion 220 has a greater volume than that of the portion without the seal protrusion 220, and therefore, insufficient filling with the material is likely to be caused in the vicinity of the tip end of the seal protrusion 220. On the other hand, the above-described configuration is employed so that the difference in the flow of the material in the vicinity of the seal protrusion 220 can be reduced, and therefore, insufficient filling with the material in the vicinity of the tip end of the seal protrusion 220 can be reduced.

Further, the through-hole 120 according to the present embodiment is formed so as not to overlap with the lines 102 of the FPC 100, and is the long hole elongated in the direction in which the lines 102 extend. With this configuration, the area of the through-hole 120 can be expanded without an adverse effect on the lines.

### Second Embodiment

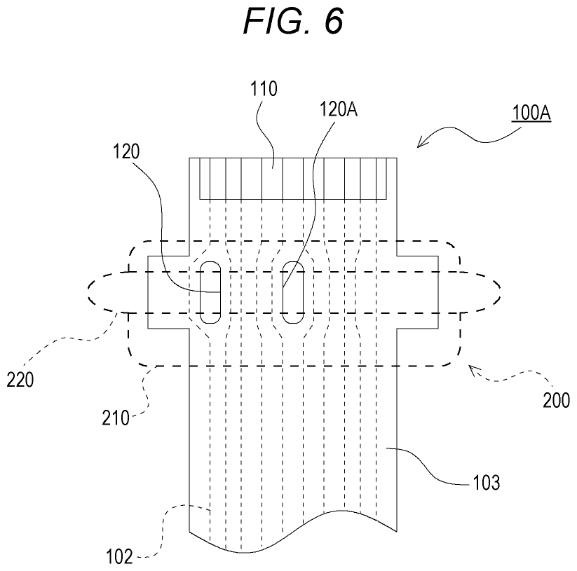

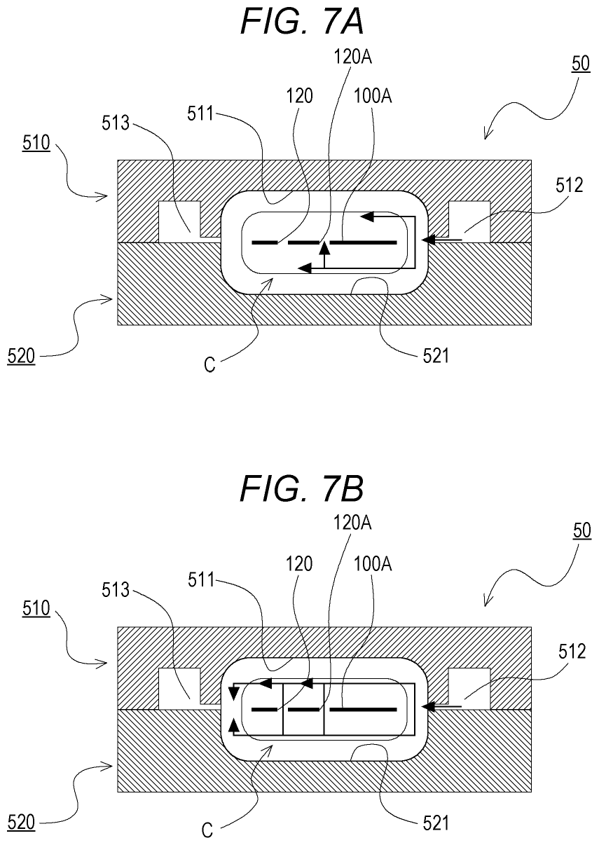

A second embodiment of the present disclosure is shown in FIGS. 6, 7A, and 7B. In the present embodiment, another through-hole is further formed in an FPC in addition to the configuration of the above-described first embodiment. Other configurations and features are the same as those of the first embodiment, and therefore, the same reference numerals are used to represent the same components and description thereof may be omitted as necessary.

FIG. 6 is a partial plan view of a flexible printed wiring board according to the second embodiment of the present disclosure. Note that in FIG. 6, a position at which a gasket is provided is indicated by a dashed line. FIGS. 7A and 7B are views for describing a method for manufacturing a gasket-equipped flexible printed wiring board according to the second embodiment of the present disclosure. Note that FIGS. 7A and 7B show the flow of a molding material in insert molding, FIG. 7A showing a state at an initial stage of molding and FIG. 7B showing a state at a late stage of molding.

The gasket-equipped flexible printed wiring board according to the present embodiment is different in that in an FPC 100A, not only the through-hole 120 described above in the first embodiment is formed, but also a through-hole 120A is formed at the center of the FPC 100A in a width direction thereof within a region embedded in a gasket 200. A configuration of the gasket 200 is the same as that of the first embodiment.

In a case where there is a significant difference in the flow of the material between the lower die 520 side and the upper die 510 side in the gasket-equipped flexible printed wiring board 10 described above in the first embodiment, it is sometimes difficult to cause, only with one through-hole 120, the material flows on the upper and lower sides of the FPC 100A to be joined together in the vicinity of a vent 513. In this case, the configuration of the FPC 10A according to the present embodiment is suitably employed. In the case of the present embodiment, part of the material flowing on the lower die 520 side flows to the upper die 510 side through the center through-hole 120A (see FIG. 7A), and also flows to the upper die 510 side through the through-hole 120 closer to the vent 513 (see FIG. 7B). Accordingly, the material flows on both sides can be joined together in the vicinity of the vent 513.

As described above, in the present embodiment, advantageous effects similar to those of the above-described first embodiment can also be obtained. Note that the position of the through-hole 120A may only be required to be such a position that advantageous effects similar to those of the present embodiment can be obtained and is not limited to the center of the FPC 100A in the width direction thereof. Similarly, the number of through-holes is not limited to two, and may be three or more.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A gasket-equipped flexible printed wiring board comprising:
a flexible printed wiring board with a through-hole; and
a gasket,
wherein the gasket is provided integrally with the flexible printed wiring board so as to embed a partial region of the flexible printed wiring board in such a manner that the gasket is molded on the flexible printed wiring board, which is an insert component, by insert molding,
the gasket has a gate mark on a first end side of the flexible printed wiring board in a width direction thereof, and
the through-hole is, within the partial region of the flexible printed wiring board, formed at a position closer to a second end side, which faces the first end side in the width direction, than to the first end side.

2. The gasket-equipped flexible printed wiring board according to claim 1, wherein
the gasket has an annular seal protrusion, and the seal protrusion is provided so as to surround the flexible printed wiring board, and
in a case where the flexible printed wiring board is vertically seen through a surface thereof, the through-hole is formed so as to protrude from both sides of the seal protrusion in a lateral direction thereof.

3. The gasket-equipped flexible printed wiring board according to claim 1, wherein
the flexible printed wiring board has a plurality of lines, and the through-hole is a long hole elongated in a direction in which the lines extend and is formed so as not to overlap with the lines.

4. A method for manufacturing a gasket-equipped flexible printed wiring board, comprising:
forming a through-hole at a position closer to a second end side, which faces a first end side of a flexible printed wiring board in a width direction thereof, than to the first end side;
preparing a die having an arrangement portion in which the flexible printed wiring board is to be arranged and a gate and a vent each formed on both sides of the arrangement portion;
arranging the flexible printed wiring board in the arrangement portion of the die such that the through-hole is at a position closer to the vent than to the gate; and
molding a gasket integrally with the flexible printed wiring board by injecting a material into a cavity of the die through the gate after the die has been clamped.
